(19) United States
(12) Patent Application Publication
(10) Pub. No.: US 2011/0126242 A1
(43) Pub. Date: May 26, 2011

(54) Inflight entertainment system with screen configurable video display unit roles

(76) Inventors: Douglas Cline, Long Beach, CA (US); Gregory C. Petrisor, Los Angeles, CA (US); John Rolf Wicklund, Laguna Beach, CA (US)

(21) Appl. No.: 12/927,736

(22) Filed: Nov. 22, 2010

Related U.S. Application Data
(60) Provisional application No. 61/283,031, filed on Nov. 25, 2009.

(51) Int. Cl. H04N 7/18; G06F 3/041

(52) U.S. Cl. 725/76; 345/173

(57) ABSTRACT

An inflight entertainment (IFE) system provides screen configurable video display unit (VDU) roles. Screen configurable VDU roles allow a role for each VDU in the system to be specified in the field through user inputs on the VDU and advertised to the head end system to create awareness of the specified role. Screen configurable VDU roles can reduce the number of discrete VDU line replaceable unit (LRU) types deployed on a single aircraft and across a fleet of aircraft, reducing hardware and software upgrade and sparing costs, while adding substantial flexibility to the system by removing cabin positioning restrictions on certain VDU types and facilitating system reconfiguration.

### CROSS-REFERENCE TO RELATED APPLICATION

This application claims the benefit of U.S. provisional application No. 61/283,031 entitled “INFLIGHT ENTERTAINMENT SYSTEM WITH SCREEN CONFIGURABLE VIDEO DISPLAY UNIT ROLES,” filed on Nov. 25, 2009, the contents of which are incorporated herein by reference.

### BACKGROUND OF THE INVENTION

The present invention relates to inflight communication systems and, more particularly, to configuration of video display units (VDUs) in an inflight entertainment (IFE) system.

Modern passenger aircraft are equipped with an IFE system having VDUs mounted at various cabin locations and serving in various roles. The head end system must know the role of each VDU to deliver appropriate services to the VDU.

Conventionally, each IFE system VDU has served in a fixed role defined by its line replaceable unit (LRU) type. Reliance on fixed role VDUs has led to a large number of VDU LRU types on a single aircraft and across a fleet of aircraft. An LRU is a complex component (i.e., “black box”) on an aircraft that is designed to be replaced quickly on the flight line or airport ramp area. To be installed on an aircraft, an LRU hardware design configuration must be approved by the Federal Aviation Administration by means defined in Title 14 of the Code of Federal Regulations. An IFE system's installation costs, operating costs, maintenance costs and passenger comfort depend greatly on the size, form factor, number and weight of its LRUs, as well as the number of distinct LRU types deployed in a single aircraft and across an airline's fleet. Thus, deployment of fixed role VDUs has added to IFE system acquisition, operating and maintenance costs, as hardware and software upgrades must be separately provided and ample spares stocked for each VDU LRU type.

Other IFE systems rely on hard coded identifiers or factory settings in VDU receptacles to define VDU roles. However, many airlines change their aircraft seating arrangements on a regular basis and these approaches limit flexibility when rearranging seating. Moreover these approaches require additional sparing as VDUs are only interchangeable with other VDUs that have the same hard coded or factory defined role.

Moreover, conventionally, VDU roles have been tied to static mapping. For example, in some IFE systems, the role for each VDU is linked to the physical port on which the VDU is connected to the system. The use of static mapping to define VDU roles has increased the complexity of LRU design (including VDU LRU design) as each LRU must generally acquire the static map and resolve its location within the map. This process is further complicated when VDUs are connected to the system on multiple paths to provide failover capability. Furthermore, the use of static mapping means that system wiring is tightly coupled to system software and changes or errors in the wiring that are not properly reflected in the static map, or vice versa, may render the system or portions of the system inoperative. In that event, system reconfiguration often cannot be done in the field and requires a software upgrade.

### SUMMARY OF THE INVENTION

The present invention, in a basic feature, provides an IFE system with screen configurable VDU roles. Screen configurable VDU roles allow a role for each VDU in the system to be specified in the field through user inputs on the VDU and advertised to the head end system to create awareness of the specified role. Screen configurable VDU roles can reduce the number of discrete VDU LRU types deployed on a single aircraft and across a fleet of aircraft, reducing hardware and software upgrade and sparing costs, while adding substantial flexibility to the system by removing cabin positioning restrictions on certain VDU LRU types and facilitating system reconfiguration.

In one aspect of the invention, an IFE system comprises a head end system and a plurality of VDUs communicatively coupled with the head end system, wherein the head end system generates a role specification for a first VDU based on user inputs received on at least one of the VDUs and enables a role specific service set for the first VDU based on the role specification.

In some embodiments, the head end system stores the role specification for the first VDU in a configuration database.

In some embodiments, the head end system stores the role specification for the first VDU in association with a media access control (MAC) address of the first VDU.

In some embodiments, the user inputs are entered into a role configuration page.

In some embodiments, the role configuration page requests a passenger class identity. In some embodiments, the passenger class identity is selected from the group consisting of first class, business class and economy class.

In some embodiments, the role configuration page requests a display type identity. In some embodiments, the display type identity is selected from the group consisting of touch screen display, non-touch screen display, passenger control unit (PCU) display, overhead display, flight attendant control panel (ACP), order panel and point of sale panel.

In some embodiments, the role configuration page requests a cabin location identity. In some embodiments, the cabin location identity is a passenger seat identifier.

In some embodiments, the role specification comprises a passenger class identity.

In some embodiments, the role specification comprises a display type identity.

In some embodiments, the role specification comprises a cabin location identity.

In some embodiments, at least one of the VDUs that receives the user inputs has role configuration logic collocated with a video display.

In some embodiments, at least one of the VDUs that receives the user inputs has role configuration logic located on a device interface unit communicatively coupled with a video display.

In some embodiments, at least one of the VDUs that receives the user inputs has user interface and a network interface both of which are communicatively coupled with a processor that executes a web browser.

In some embodiments, at least two VDUs in the plurality have a different hardware design configuration.

In some embodiments, at least two VDUs in the plurality have the same hardware design configuration.

In some embodiments, the user inputs are received on a touch screen.

In some embodiments, the user inputs are received on an input device connected to an exposed connector of at least one of the VDUs that receives the user inputs.

In some embodiments, the user inputs are received on the first VDU.

In some embodiments, the user inputs are received on a second VDU.

In some embodiments, the user inputs include a unique identifier of the first VDU. In some embodiments, the unique identifier is a MAC address.

In some embodiments, the user inputs include a selection of a unique identifier of the first VDU made in response to an output signal outputted on the first VDU.

In another aspect of the invention, a VDU for an IFE system comprises a user interface, a network interface and a processor communicatively coupled with the user interface and the network interface, wherein under control of the processor the VDU transmits to a head end system a role specification generated based on user inputs on the user interface and in response receives from the head end system via the network interface services within a role specific service set enabled by the head end system based on the role specification.

In some embodiments, the user inputs are entered into a role configuration page.

In some embodiments, the role configuration page requests a passenger class identity. In some embodiments, the passenger class identity is selected from the group consisting of first class, business class and economy class.

In some embodiments, the role configuration page requests a display type identity. In some embodiments, the display type identity is selected from the group consisting of touch screen display, non-touch screen display, PCU display, overhead display, ACP, order panel and point of sale panel.

In some embodiments, the role configuration page further requests a cabin location identity. In some embodiments, the cabin location identity is a passenger seat identifier.

In some embodiments, the role specification comprises a passenger class identity.

In some embodiments, the role specification comprises a display type identity.

In some embodiments, the role specification comprises a cabin location identity.

In some embodiments, the user inputs are received on a touch screen of the user interface.

In some embodiments, the user inputs are received on an input device connected to an exposed connector of the user interface.

In yet another aspect of the invention, a method for VDU role provisioning in an IFE system comprises the steps of inputting on a VDU user inputs, generating on the VDU a role specification based on the user inputs, transmitting from the VDU to a head end system the role specification and enabling by the head end system a role specific service set for the VDU based on the role specification.

In some embodiments, the method further comprises the step of providing by the head end system to the VDU services within the role specific service set.

In some embodiments, the method further comprises the step of acquiring by the VDU from the head end system an Internet Protocol (IP) address of the VDU.

In some embodiments, the method further comprises the step of acquiring by the VDU from the head end system an IP address of a management server of the head end system.

In some embodiments, the method further comprises the step of using by the management server a MAC address of the VDU to check for a configuration record for the VDU.

In some embodiments, the enabling step comprises creating by the management server a configuration record for the VDU based on the role specification.

These and other aspects will be better understood by reference to the following detailed description taken in conjunction with the drawings that are briefly described below. Of course, the invention is defined by the appended claims.

### BRIEF DESCRIPTION OF THE DRAWINGS

FIG. 1 shows an IFE system in some embodiments of the invention.

FIG. 2 shows a role configuration database in some embodiments of the invention.

FIG. 3 shows a role configuration page presented on a VDU in some embodiments of the invention.

FIG. 4 shows a test page presented on a VDU in some embodiments of the invention.

FIG. 5 illustrates integration of common VDU logic on various LRU types in some embodiments of the invention.

FIG. 6 shows a method for VDU role provisioning on an IFE system in some embodiments of the invention.

### DETAILED DESCRIPTION OF A PREFERRED EMBODIMENT

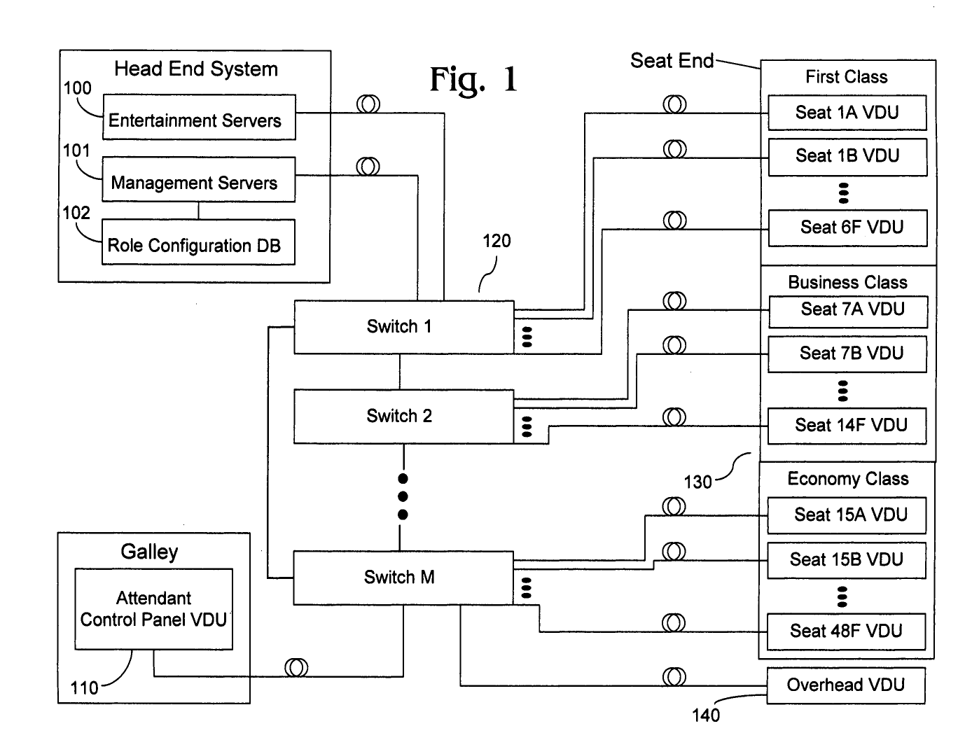

FIG. 1 shows an IFE system in some embodiments of the invention. The IFE system includes a head end system having entertainment servers 100, management servers 101 and a role configuration database 102. Entertainment servers 100 include one or more audio servers, video servers, game servers, file servers and/or passenger information system servers that deliver data to seat VDUs 130 as well as ACP VDU 110 and overhead VDU 140. These data conform to service sets for which individual ones of VDUs 130, 110, 140 have been enabled. Management servers 101 include one or more application servers, configuration servers, Dynamic Host Configuration Protocol (DHCP) servers and Domain Name System (DNS) servers that interoperate with ones of VDUs 130, 110, 140 and role configuration database 102 to enable service sets for ones of VDUs 130, 110, 140 based on role specifications inputted into ones of VDUs 130, 110, 140 and provided to management servers 101.

The IFE system also includes switches 120 that together form a switch matrix interconnecting the head end system, the galley and the seat end via fiber optic cables. The galley includes ACP VDU 110 and the seat end includes a plurality of seat VDUs 130. Overhead VDU 140 may be mounted to the cabin ceiling. VDUs 110, 130, 140 each have a cabin location identity, such as a passenger seat identifier in the case of seat VDUs 130 or a cabin section number, overhead display number or ACP number in the case of VDUs 110, 140 that are not linked to a specific passenger seat. VDUs 110, 130, 140 also each have a display type identity, such as touch screen display, non-touch screen display, PCU display, overhead display, ACP, order panel or point of sale panel. Additionally, seat VDUs 130 have a passenger class identity, such as first class (seats 1A-6F), business class (seats 7A-14F) or economy class (seats 15A-48F). Cabin location identity, passenger class identity (where available) and display type identity together define a VDU role. In an important feature of the invention, VDU roles are made screen configurable and reconfigurable. While specific VDUs 110, 130, 140 are shown for illustrative purposes, an WE system may have additional or different VDUs serving in various roles.

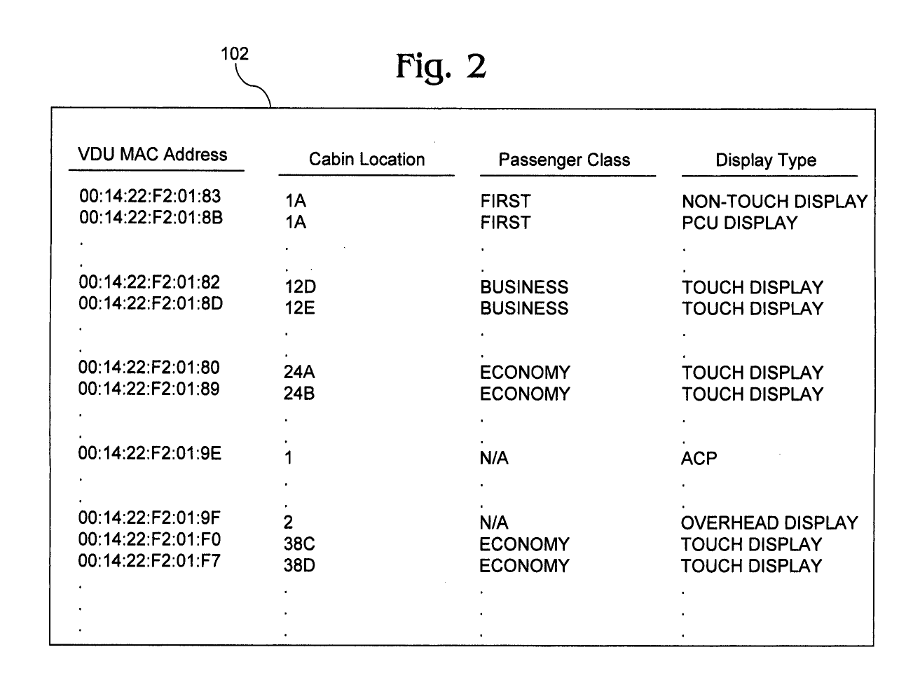

FIG. 2 shows role configuration database 102 in some embodiments of the invention. Role configuration database 102 includes multiple entries each having a configuration record corresponding to a different VDU. Each configuration record includes a MAC address, cabin location identity, passenger class identity (where available) and display type identity. The cabin location identity, passenger class identity (where available) and display type identity together define a role specification for a VDU. Configuration records are created, modified and removed by management servers 101, generally based on user inputs received from the associated VDU while in configuration mode. VDU MAC addresses are used as lookup keys to access these records. Management servers 101 enable role specific service sets for VDUs by creating or modifying configuration records and provide services within role specific service sets to VDUs based on the contents of these records.

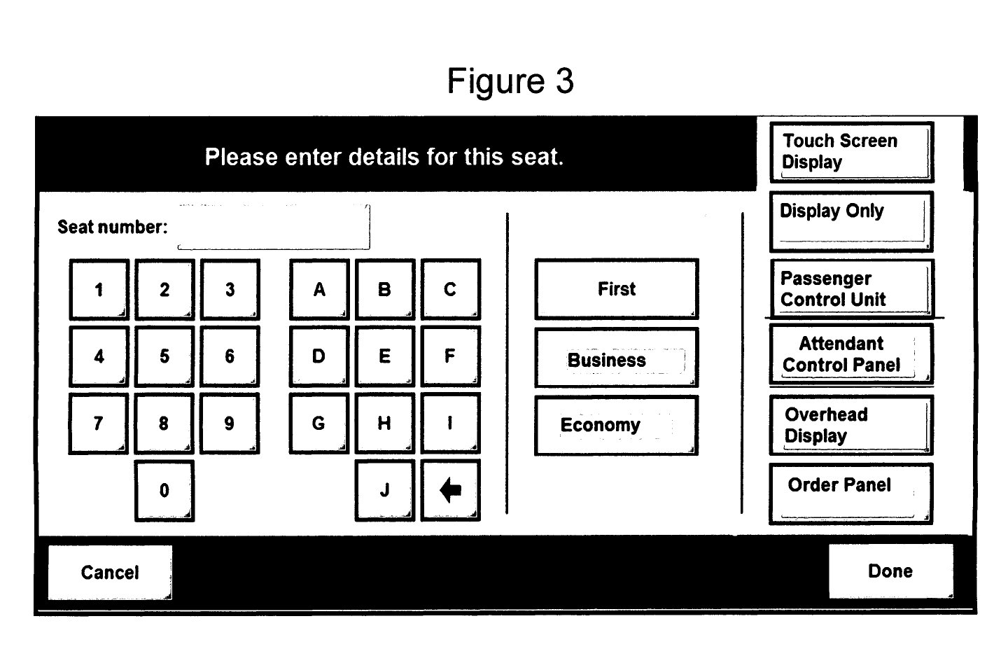

FIG. 3 shows a role configuration page 300 presented on a VDU in some embodiments of the invention. Role configuration page 300 is rendered on a screen of the VDU, which may be a touch screen. Role configuration page 300 allows an administrative user, such as an IFE system administrator or flight attendant, to define a role for the VDU in situ after the VDU is installed on an aircraft. On the left side of page 300, the administrative user inputs a cabin location identity, which is typically a seat number (e.g., row number and alphabetic column) of a passenger who will use the VDU during flight, but may alternatively be another type of identifier. The cabin location identity is input by depressing alphabetic and numeric buttons displayed on screen. To the right of the cabin location identity entry area is a passenger class identity input area, wherein the administrative user selects a passenger class identity (if any) from a discrete list of passenger classes (e.g., first, business, economy) by depressing a button. The passenger class identity specifies the class of the passenger who will be using the VDU in flight, and facilitates provision of differentiated IFE services to different classes of passengers. To the right of the passenger class identity input area is a display type identity area, wherein the administrative user selects a display type from a discrete list of types [e.g., touch screen display, display only (non-touch screen display), PCU display, overhead display, ACP, order panel, point of sale panel] by depressing a button. Role configuration page 300 also provides a “Cancel” button that allows the administrator to cancel configuration and a “Done” button to implement the configuration. Role configuration page 300 provides the administrative user the ability to rapidly and flexibly configure and reconfigure the IFE system architecture after the system is powered-up.

Where a VDU to be configured does not have a touch screen, the VDU may be configured by other means. For example, an input device may be attached to an exposed connector on the VDU and used to input VDU role information on role configuration page 300. Alternatively, where the MAC address of the VDU to be configured is known, the VDU may be remotely configured from another VDU touch screen by inputting or selecting the MAC address of the VDU to be configured from a list of MAC addresses associated with VDUs having undefined roles, then inputting VDU role information on role configuration page 300. Alternatively, where the MAC address of the VDU to be configured is unknown, the VDU may be remotely configured from another VDU touch screen by scrolling a list of MAC addresses associated with VDUs having undefined roles until a video or audio signal is outputted from the VDU to be configured, which output signal indicates that the MAC address currently selected on the list is the MAC address of the VDU to be configured, then selecting the MAC address and inputting VDU role information on role configuration page 300.

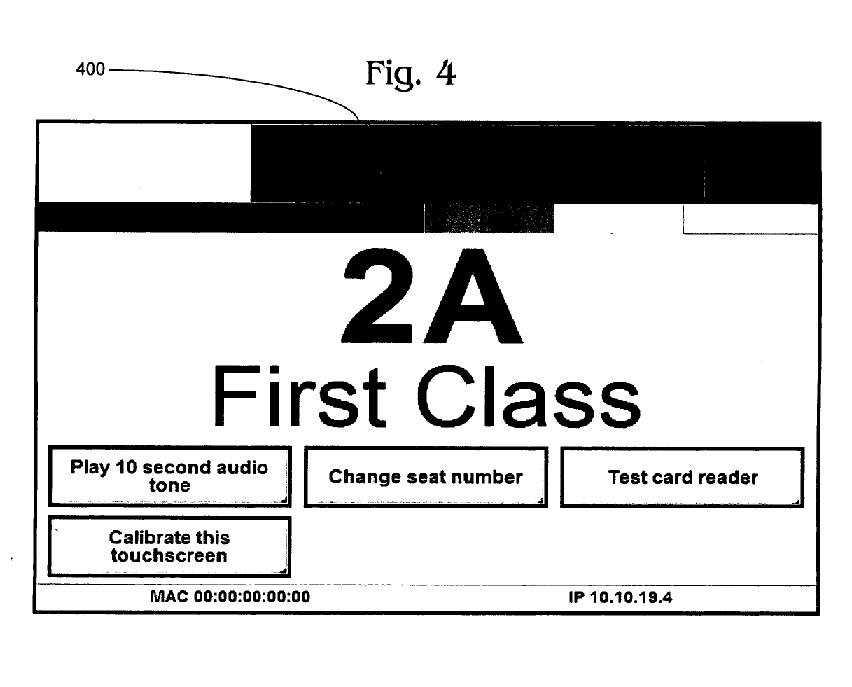

FIG. 4 shows a test page 400 presented on a VDU in some embodiments of the invention. Test page 400 prominently displays the cabin location identity and passenger class identity of the VDU. Test page 400 is the default maintenance mode page. Accordingly, when the IFE system is in maintenance mode, an administrative user can walk through the aircraft and visually inspect and verify the entire configuration for an installed shipset of VDUs. As shown in the figure, test page 400 may also display other configuration information (e.g., MAC address) and test buttons that may be useful for IFE system maintenance. In systems with more than one display type, the display type would also be displayed on test page 400.

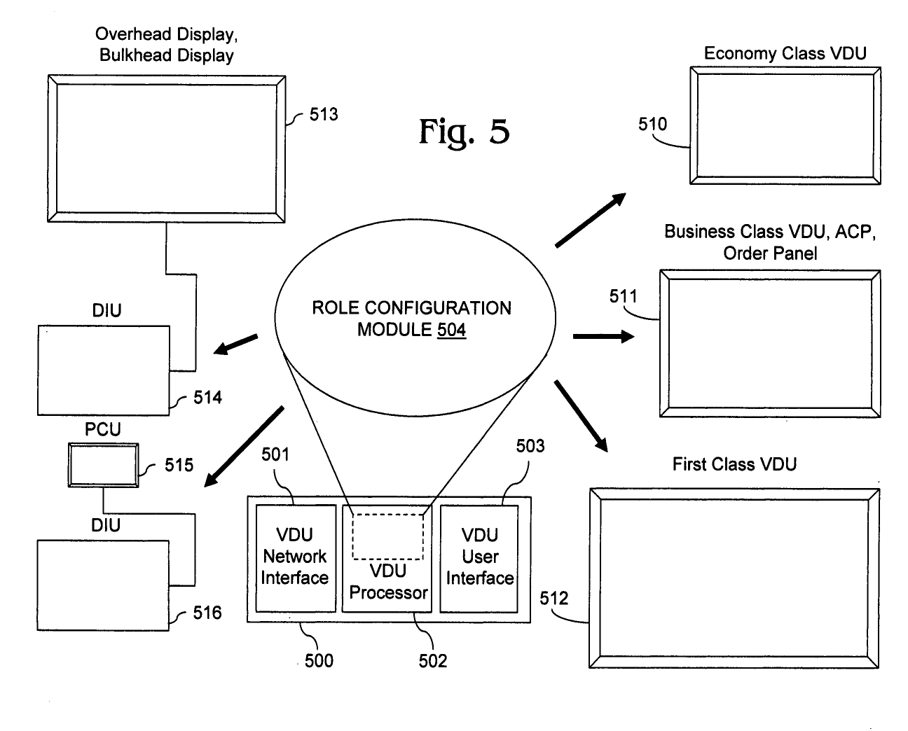

FIG. 5 illustrates integration of common VDU role configuration logic 500 on various VDU LRU types within a single IFE system in some embodiments of the invention. Common role configuration logic 500 includes a network interface 501 and a user interface 503, both of which are communicatively coupled with a processor 502 that executes a VDU role configuration module 504. Module 504 comprises a web browser and interacts with the head end system during VDU role configuration. Common role configuration logic 500 is operative on all VDUs in the IFE system. By deploying common role configuration logic 500 on all VDUs across the IFE system, an entire installed shipset of VDUs can be configured using a common web based method and common configuration screens.

As shown in FIG. 5, common role configuration logic 500 may be integrated on different VDU LRU types. The figure also shows that a particular VDU LRU type can be configured to serve in different roles. For example, VDU LRU 511 can serve as a business class VDU, an ACP or an order panel depending on screen configuration after deployment. The figure further illustrates that common role configuration logic 500 may be integrated into either a video display 510, 511, 512 of a VDU LRU or a display interface unit (DIU) 514, 516 of a VDU LRU that drives the video display. DIU integration allows the IFE system to include video displays provided by third party manufacturers that do not permit integration of common role configuration logic, such as an overhead or bulkhead display 513. Finally, the figure shows DIU 516 driving a display on a PCU 515 that for mechanical (e.g., size) and/or environmental (e.g., cooling) reasons does not permit integration of common role configuration logic. The use of common role configuration logic 500 as illustrated in FIG. 5 enables a common IFE system configuration methodology that expedites configuration, allows for VDUs having different sizes and allows VDUs to be moved and easily reconfigured within an aircraft, within in a fleet of like aircraft, or within a fleet of disparate aircraft.

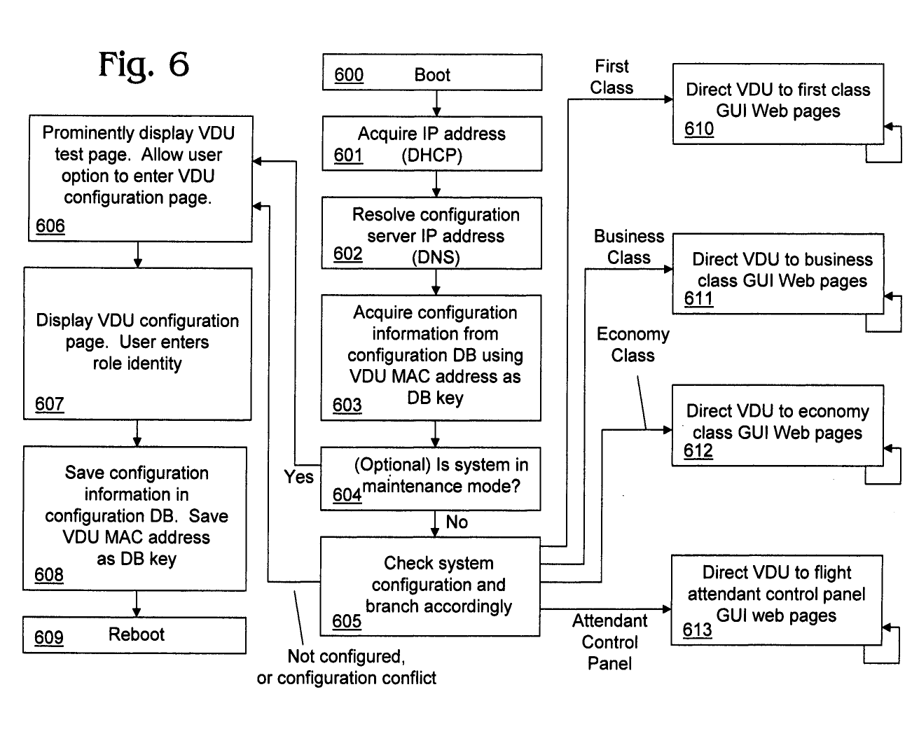

FIG. 6 shows a method for VDU role provisioning on an IFE system in some embodiments of the invention. This method is individually performed by or for all VDUs in the IFE system using common logic. In Step 600, the VDU boots under control of the VDU processor. In Step 601, the VDU processor acquires its dynamic IP address from a DHCP server at the head end system. In other embodiments, an alternative IP addressing method may be used, such as hard coding a static IP address on the VDU. In Step 602, the VDU processor acquires from a DNS server the IP address of a configuration server at the head end system. Alternatively, the IP address of the configuration server may be hard coded on the VDU. In Step 603, the VDU processor in consultation with the configuration server retrieves the configuration record for the VDU (if one exists) from the role configuration database. The MAC address of the VDU is used as a lookup key in the role configuration database. If there is no configuration record, the configuration server creates a “blank” entry (if one does not already exist) in the role configuration database for the VDU's MAC address, creating a presence in the system of a VDU having an undefined role. In Step 604, after acquisition of the configuration record (if one exists), the VDU processor in consultation with the configuration server determines if the IFE system is in maintenance mode. If the IFE system is in maintenance mode, the VDU processor in Step 606 displays the test page and allows the user to enter the role configuration page. If the system is not in maintenance mode, the VDU processor analyzes the configuration record in Step 605. If the configuration record is “blank” or is in conflict with another configuration record, the VDU processor in Step 606 displays the test page and allows the user to enter the role configuration page. In Step 607, an administrator can input on the role configuration page the cabin location identity, passenger class identity and display type identity, after which the VDU processor advances to Step 608 where the role specification is stored to the configuration record after which the system reboots at Step 609. If the configuration record is not “blank” and is not in conflict, the VDU processor retrieves and displays the root graphical user interface (GUI) web page conforming to the service set for the VDU's role specification as indicated in the configuration record. For example, if the passenger class identity is first class, then the VDU processor retrieves the root GUI web page for first class as illustrated in Step 610. The figure also illustrates this process for business class (Step 611) and economy class (Step 612). Similarly, if the display type identity is ACP, the VDU processor retrieves the root GUI web page for ACP as illustrated in Step 613. Naturally, an IFE system may include additional or different root GUI web pages associated with different class and display types. The root GUI web pages are retrieved from the head end system (e.g., application server) and delivered to the VDU via the VDU network interface. The in-flight user of the VDU (e.g., passenger) accesses services within the service set for the VDU through user inputs on the root GUI web page, and the head end system (e.g., entertainment servers) provides the services to the VDU.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. An inflight entertainment (IFE) system, comprising:
a head end system; and
a plurality of video display units (VDUs) communicatively coupled with the head end system, wherein the head end system generates a role specification for a first VDU based on user inputs received on at least one of the VDUs and enables a role specific service set for the first VDU based on the role specification.

2. The IFE system of claim 1, wherein the head end system stores the role specification for the first VDU in a configuration database.

3. The IFE system of claim 1, wherein the head end system stores the role specification for the first VDU in association with a media access control (MAC) address of the first VDU.

4. The IFE system of claim 1, wherein the user inputs are entered into a role configuration page.

5. The IFE system of claim 4, wherein the role configuration page requests a passenger class identity.

6. The IFE system of claim 5, wherein the passenger class identity is selected from the group consisting of first class, business class and economy class.

7. The IFE system of claim 4, wherein the role configuration page requests a display type identity.

8. The IFE system of claim 7, wherein the display type identity is selected from the group consisting of touch screen display, non-touch screen display, passenger control unit (PCU) display, overhead display, flight attendant control panel (ACP), order panel or point of sale panel.

9. The IFE system of claim 4, wherein the role configuration page requests a cabin location identity.

10. The IFE system of claim 9, wherein the cabin location identity is a passenger seat identifier.

11. The IFE system of claim 1, wherein the role specification comprises a passenger class identity.

12. The IFE system of claim 1, wherein the role specification comprises a display type identity.

13. The IFE system of claim 1, wherein the role specification comprises a cabin location identity.

14. The IFE system of claim 1, wherein at least one of the VDUs that receives the user inputs has role configuration logic collocated with a video display.

15. The IFE system of claim 1, wherein at least one of the VDUs that receives the user inputs has role configuration logic located on a device interface unit communicatively coupled with a video display.

16. The IFE system of claim 1, wherein at least one of the VDUs that receives the user inputs has user interface and a network interface both of which are communicatively coupled with a processor that executes a web browser.

17. The IFE system of claim 1, wherein at least two VDUs in the plurality have a different hardware design configuration.

18. The IFE system of claim 1, wherein at least two VDUs in the plurality have the same hardware design configuration.

19. The IFE system of claim 1, wherein the user inputs are received on a touch screen.

20. The IFE system of claim 1, wherein the user inputs are received on an input device connected to an exposed connector of at least one of the VDUs that receives the user inputs.

21. The IFE system of claim 1, wherein the user inputs are received on the first VDU.

22. The IFE system of claim 1, wherein the user inputs are received on a second VDU.

23. The IFE system of claim 22, wherein the user inputs include a unique identifier of the first VDU.

24. The IFE system of claim 23, wherein the unique identifier is a MAC address.

25. The IFE system of claim 22, wherein the user inputs include a selection of a unique identifier of the first VDU made in response to an output signal outputted on the first VDU.

26. A VDU for an IFE system, comprising:
a user interface;
a network interface; and
a processor communicatively coupled with the user interface and the network interface, wherein under control of the processor the VDU transmits to a head end system a role specification generated based on user inputs on the user interface and in response receives from the head end system via the network interface services within a role specific service set enabled by the head end system based on the role specification.

27. The VDU of claim 26, wherein the user inputs are entered into a role configuration page.

28. The VDU of claim 27, wherein the role configuration page requests a passenger class identity.

29. The VDU of claim 28, wherein the passenger class identity is selected from the group consisting of first class, business class and economy class.

30. The VDU of claim 27, wherein the role configuration page requests a display type identity.

31. The VDU of claim 30, wherein the display type identity is selected from the group consisting of touch screen display, non-touch screen display, PCU display, overhead display, ACP, order panel or point of sale panel.

32. The VDU of claim 27, wherein the role configuration page requests a cabin location identity.

33. The VDU of claim 32, wherein the cabin location identity is a passenger seat identifier.

34. The VDU of claim 26, wherein the role specification comprises a passenger class identity.

35. The VDU of claim 26, wherein the role specification comprises a display type identity.

36. The VDU of claim 26, wherein the role specification comprises a cabin location identity.

37. The VDU of claim 26, wherein the user inputs are received on a touch screen of the user interface.

38. The VDU of claim 26, wherein the user inputs are received on an input device connected to an exposed connector of the user interface.

39. A method for VDU role provisioning in an IFE system, comprising the steps of:
inputting on a VDU user inputs;
generating on the VDU a role specification based on the user inputs;
transmitting from the VDU to a head end system the role specification; and
enabling by the head end system a role specific service set for the VDU based on the role specification.

40. The method of claim 39, further comprising the step of providing by the head end system to the VDU services within the role specific service set.

41. The method of claim 39, further comprising the step of acquiring by the VDU from the head end system an Internet Protocol (IP) address of the VDU.

42. The method of claim 39, further comprising the step of acquiring by the VDU from the head end system an IP address of a management server of the head end system.

43. The method of claim 42, further comprising the step of using by the management server a MAC address of the VDU to check for a configuration record for the VDU.

44. The method of claim 42, wherein the enabling step comprises creating by the management server a configuration record for the VDU based on the role specification.
